(19) United States
(12) Patent Application Publication
(10) Pub. No.: US 2007/0286980 A1
(43) Pub. Date: Dec. 13, 2007

(54) Write-once type multilayer optical disc, recording method, reproducing method, and recording device

(76) Inventors: Yasuaki Ootera, Yokohama-shi (JP); Kazuyo Umezawa, Yokohama-shi (JP); Koji Takazawa, Tokyo (JP); Naoki Morishita, Yokohama-shi (JP); Hideo Ando, Hino-shi (JP); Seiji Morita, Yokohama-shi (JP); Naomasa Nakamura, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/810,586

(22) Filed: Jun. 6, 2007

(30) Foreign Application Priority Data
Jun. 8, 2006 (JP) 2006-160040

(51) Int. Cl. B32B 3/02

(52) U.S. Cl. 428/64.4

(57) ABSTRACT

Manufacturing of a higher quality write-once type multilayer optical disc is facilitated. The optical disc includes a plurality of recording layers in which recording or reproduction is carried out by a blue or blue-violet laser beam of a wavelength of about 405 nm. Each of the recording layers includes a recording layer which uses an organic dye. The plurality of recording layers includes a layer in which a groove pattern around a recording mark is deformed when information is recorded, and a layer in which the groove pattern around the recording mark is not deformed when information is recorded.

### CROSS-REFERENCE TO RELATED APPLICATIONS

This application is based upon and claims the benefit of priority from Japanese Patent Application No. 2006-160040, filed Jun. 8, 2006, the entire contents of which are incorporated herein by reference.

### BACKGROUND

1. Field

This invention relates to a write-once type multilayer optical disc which includes two or more recording layers in one surface.

2. Description of the Related Art

A dual-layer DVD-R disc that includes L0 and L1 recording layers has been in practical use as a write-once type multilayer optical disc. In this dual-layer DVD-R disc, normally, the L0 is disposed on a polycarbonate substrate, and the L1 layer is disposed on an intermediate layer made of an ultraviolet curing resin (photopolymer).

In a write-once type optical disc such as a DVD-R, a substrate resin is deformed by heat generated by chemical reaction of a dye to record a mark. Accordingly, a volume change amount of the substrate resin during heating affects quality of a recording mark. As a conventional art, Jpn. Pat. Appln. KOKAI Publication No. 2005-332564 discloses a technology mainly designed to secure quality of a recording mark. According to this technology, deterioration of recording characteristics of a recording layer formed on an intermediate layer is prevented by suppressing deformation of a groove formed in the intermediate layer. In other words, by defining heat characteristics of the ultraviolet curing resin of the L1 layer, quality of the recording mark in the dual-layer DVD-R is secured (paragraph 0007 of Jpn. Pat. Appln. KOKAI Publication No. 2005-332564). Another related conventional technology is disclosed in Jpn. Pat. Appln. KOKAI Publication No. 2005-129199.

In a next-generation write-once type multilayer optical disc (e.g., single-sided dual-layer HD_DVD-R using a laser beam of a wavelength 405 nm), its recording principle does not exactly match that of a current DVD-R (using a laser beam of a wavelength 650 nm). Thus, a method of Jpn. Pat. Appln. KOKAI Publication No. 2005-332564 cannot be directly applied to the next-generation write-once type multilayer optical disc. According to the technology of Jpn. Pat. Appln. KOKAI Publication No. 2005-332564, a difference is set in characteristics between a pattern transfer photopolymer of the L1 layer and an adhesive photopolymer. However, sufficient consideration is not given to the other recording layers such as the L0 layer.

The technology of Jpn. Pat. Appln. KOKAI Publication No. 2005-129199 only defines characteristics of a photopolymer used for the L1 layer. No consideration is given to characteristics of photopolymers for the other layers such as the L0 layer (recording layers other than the L0, L1 layers in a multilayer disc of three layers or more). No consideration is given to the recording principle or a reflectance change in the next-generation write-once type multilayer optical disc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagrams showing a configuration example of a multilayer optical disc according to an embodiment of the invention;

FIG. 2 is an exemplary diagram showing formation of a burst cutting area (BCA) in an L1 layer of the write-once type single-sided multilayer (2 layers) optical disc according to an embodiment of the invention;

FIGS. 3A and 3B are exemplary diagrams each showing a contents example of a BCA record recorded in the BCA of FIG. 2;

FIG. 4 is an exemplary diagram showing a configuration example of a device for recording specific information containing the BCA records of FIGS. 3A and 3B in the BCA of FIG. 2;

FIG. 5 is an exemplary flowchart showing an example of a process of recording specific information (BCA record) in the L1 layer of the write-once type single-sided multilayer (2 layers) optical disc of FIG. 1 or FIG. 2;

FIG. 6 is a flowchart showing an example of a process of reproducing specified information (BCA record) from the L1 layer of the write-once type single-sided multilayer (2 layers) optical disc of FIG. 1 or FIG. 2;

FIG. 7 is an exemplary diagram showing a manufacturing process example of the write-once type single-sided dual-layer optical disc of an embodiment of the invention;

FIGS. 8A and 8B are exemplary diagrams showing examples of a recording mark accompanied by substrate deformation during recording and a recording mark not accompanied by substrate deformation during recording;

FIG. 9 is an exemplary diagram showing that a proper amount of a CD-R/DVD-R dye material is mixed with an L0 layer dye material to obtain a BCA dye material for the L1 layer (diagram showing a relation between absorbances and wavelengths of organic dye materials for the L0 and L1 layers);

FIG. 10 is an exemplary diagram showing a specific example of a metal complex portion of the L0 layer organic material;

FIGS. 11A to 11C are exemplary diagrams each showing a specific example of a dye portion of the L0 layer organic material;

FIG. 12 is an exemplary flowchart showing a recording method which uses the optical disc of an embodiment of the invention; and

FIG. 13 is an exemplary flowchart showing a reproducing method which uses the optical disc of an embodiment of the invention.

### DETAILED DESCRIPTION

Various embodiments according to the invention will be described hereinafter with reference to the accompanying drawings.

One of the tasks of the embodiments is to facilitate manufacturing of a higher quality write-once type multilayer optical disc by widening a material selection range such as dyes and ultraviolet curing resins (photopolymers) used for mass disc production regarding a next-generation write-once type multilayer optical disc in which recording or reproduction is carried out by a short-wavelength laser beam of a wavelength equal to or less than 450 nm.

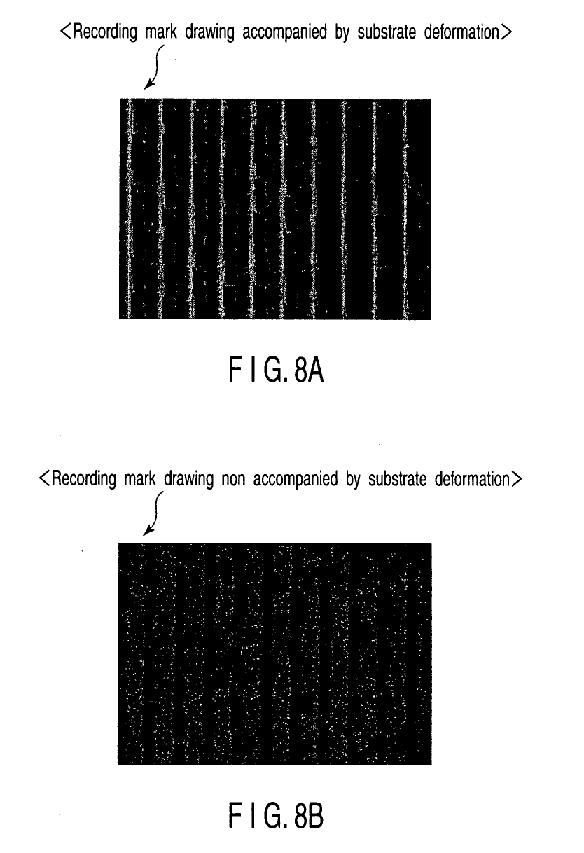

In general, according to one embodiment of the invention, the write-once type multilayer optical disc includes a plurality of recording layers (L0, L1) in which recording or reproduction is carried out by a laser beam of a wavelength equal to or less than 450 nm (e.g., 405 nm±15 nm). Each recording layer includes a recording film which uses an organic dye. The plurality of recording layers (L0 and/or L1) includes both of a layer in which a groove pattern around a recording mark is deformed when information is recorded (FIG. 8A) and a layer in which the groove pattern around the recording mark is not deformed when information is recorded (FIG. 8B).

In the next-generation type multilayer optical disc in which recording or reproduction is carried out by a short-wavelength laser beam, a material selection range such as dyes and ultraviolet curing resins (photopolymers) used for mass disc production is widened to facilitate manufacturing of a higher quality write-once type multilayer optical disc.

Between an optical disc corresponding to a red wavelength and an optical disc corresponding to a blue wavelength, there is almost no variance in structure and manufacturing method of single-sided dual-layer disc. The embodiment is directed to a next-generation optical disc (HD_DVD-R) corresponding to a blue wavelength. However, some problems occur because dye characteristics (recording principle) are different from those of a current DVD while a disc structure and a manufacturing method are similar to those of the current DVD. The embodiment solves the problems.

The embodiment provides a write-once type optical disc which has a disc diameter of 120 mm and a thickness of 1.2 mm (two polycarbonate formed substrates of 0.6 mm are bonded) and includes two recording layers using organic dye materials. For a recording or reproducing light, an optical system of a wavelength 405 nm and NA 0.65 is used. A track pitch between grooves of a data recording area is 400 nm, and a disc capacity is 15 GB per layer, totally 30 GB per two layers. However, the embodiment is not limited to the aforementioned. For example, the embodiment may employ an optical disc including a cover layer of 0.1 mm formed in its surface, an optical disc of a diameter 80 mm, a higher-density pattern, or a shorter wavelength and a higher NA. Specific disc material examples are a polycarbonate for a formed substrate, azo, diazo, cyanine, phthalocyanine, styryl, or an organic dye material of these mixtures for a recording layer, silver (Ag), aluminum (L), gold (Au) or a metal compound based on these for a reflective film, and acrylic or epoxy ultraviolet curing resin for an adhesive. However, the embodiment is not limited to these materials.

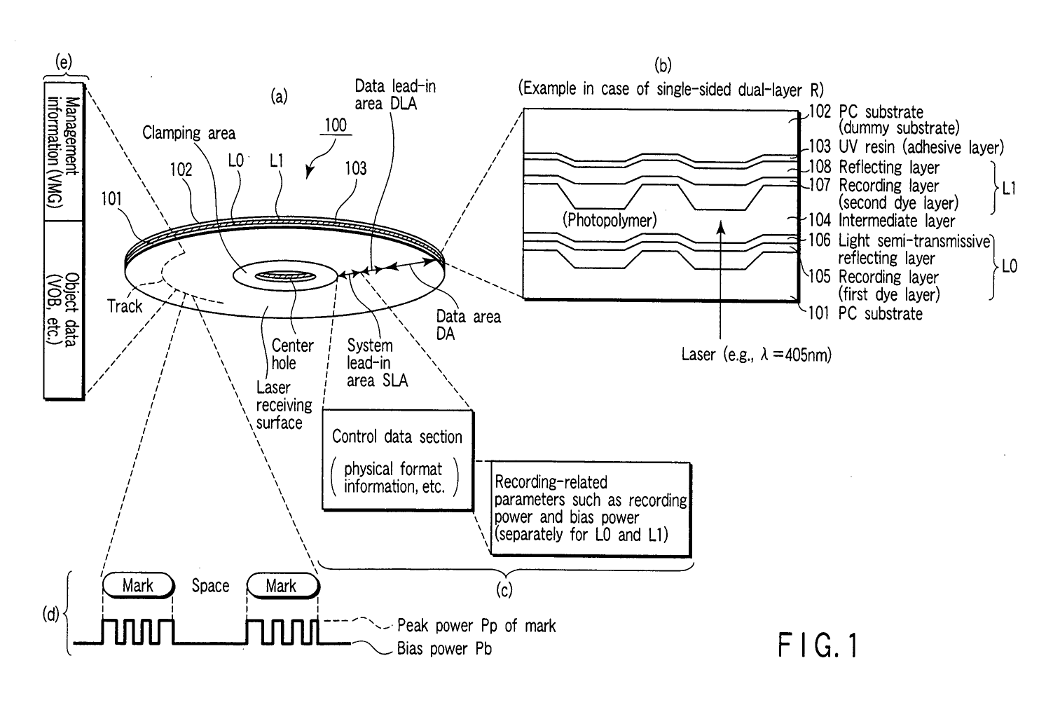

Various embodiments will be described below with reference to the drawings. FIG. 1 shows a configuration example of an optical disc (write-once type single-sided dual-layer optical disc as a specific example) 100 according to an embodiment. As shown by (a) and (b) in FIG. 1, for example, the optical disc 100 includes a transparent resin substrate 101 made of a synthetic resin material such as polycarbonate (PC) and formed into a disc shape. The transparent resin substrate 101 includes a groove formed into a concentric circular or helical shape. The transparent resin substrate 101 can be manufactured by using a stamper to execute injection molding.

That is, as seen from a recording or reproducing light incident side, an organic dye layer 105 of an L0 layer and a (semitransmissive or semireflective) metal reflective film layer 106 are disposed on the substrate 101. On its deep side, an L1 layer pattern made of a photopolymer is formed to server also as an intermediate layer 104. An organic dye layer 107 of the L1 layer and a metal reflective film layer 108 are disposed on the photopolymer. Lastly, a dummy substrate 102 is bonded by an ultraviolet curing resin 103. There is basically no change in this structure between the current DVD-R and the next-generation HD_DVD-R.

An organic dye layer 105 and a light semi-transmissive reflective layer 106 of a 1st layer (L0) are sequentially stacked on the polycarbonate transparent resin substrate 101 of a thickness 0.59 mm, and a photopolymer (2P resin) 104 is applied thereon by spin-coating. A groove shape of a 2nd layer (L1) is transferred thereto to sequentially stack an organic dye recording layer 107 and a silver or a silver alloy reflective film 108 of the 2nd layer. Another transparent resin substrate (or dummy substrate) 102 of a thickness 0.59 mm is bonded to the substrate prepared by stacking the recording layers L0 and L1 via a UV curing resin (adhesive layer) 103. The organic dye recording layers (recording layer 105 and 107) constitute a dual-layer structure which sandwich the semitransmissive reflective layer 106 and the intermediate layer 104. A total thickness of the optical disc thus completed by bonding is nearly 1.2 mm.

For example, a helical groove of a track pitch 0.4 μm and a depth 60 nm is formed (in each layer of L0 and L1) on the transparent resin substrate 101. This groove is wobbled, and address information is recorded in this wobble. Then, recording layers 105 and 107 containing organic dyes are formed on the transparent resin substrate 101 to fill the groove.

For the organic dyes of the recording layers 105 and 107, dyes whose maximum absorption wavelength areas are shifted to a long wavelength side more than a recording wavelength (e.g., 405 nm) can be used. The recording layers are designed such that absorption is not lost in a recording wavelength area but proper light absorption is obtained in a long wavelength area (e.g., 450 nm to 600 nm).

The organic dye (specific example will be described below) can be dissolved in a solvent to be a liquid, and easily applied on the transparent resin substrate surface by a spin-coating method. In this case, a film thickness can be highly accurately managed by controlling a dilution ratio of the solvent and a rotational speed during spin-coating.

A low light reflectivity may be met when a recording laser light is focused on or tracking over the track before recording of information. Thereafter, the dye is subjected to a resolving reaction by the, laser light to reduce the optical absorption rate, so that the light reflectivity at the recording mark portion is enhanced. From this, a so-called “Low-to-High” (or “L to H”) characteristic is obtained wherein the light reflectivity at the recording mark portion formed by irradiating the laser light becomes higher than the light reflectivity obtained before the laser light irradiation.

Incidentally, in transparent resin substrate 101, particularly at the groove bottom portion (of L0 or L1), some deformations may be caused by heat generated due to the irradiation of the recording laser. In this case, in a reproduction process after recording, a phase difference (compared with the case of no heat deformation) could occur in the reflected laser light. Problems due to the phase difference can be suppressed or avoided if deformations of the recording mark are prohibited or prevented by the embodiment.

Note that even if the recording mark is subjected to a deformation of the substrate at the time of recording, so long as the degree of the deformation is controlled within a prescribed management limit, recording/reproducing can be normally performed (without substantial influence of the phase difference). In the embodiment, a combination use of a recording mark with a substrate deformation at the time of recording and another recording mark without such a substrate deformation is admitted. Although described later, FIG. 8A shows an example of the recording mark (High-to-Low) with the substrate deformation, and FIG. 8B shows another example of the recording mark (Low-to-High) without the substrate deformation.

According to the embodiment, a physical format that can be applied to the L0 and L1 layers on transparent resin substrate 101 and photo polymer (2P resin) 104 may be as follows: Namely, general parameters of a recordable single-sided dual-layer disc are almost the same as those of a single-layer disc, exept for the following. That is, the user-available recording capacity is 30 GB, the inner radius of layer 0 (L0 layer) of the data area is 24.6 mm, the inner radius of layer 1 (L1 layer) thereof is 24.7 mm, and the outer radius (of each of layer 0 and layer 1) of the data area is 58.1 mm.

In optical disc 100 of FIG. 1(a), system lead-in area SLA includes a control data section as exemplified by FIG. 1(c). The control data section includes, as a part of physical format information, etc., recording-related parameters such as recording power (peak power), bias power, and the like, for each of L0 and L1.

On the track within data area DA of optical disc 100, as exemplified by FIG. 1(d), mark/space recording is done by the laser with a given recording power (peak power) and bias power. By this mark/space recording, as exemplified by FIG. 1(e), object data (such as VOB) and its management information (VMG) of a high-definition TV broadcasting program, for example, are recorded on the track (of L0 and/or L1) in data area DA.

A cyanine dye, styryl dye, azo dye, or the like may be used as an organic dye applicable to the embodiment. Particularly, the cyanine dye or the styryl dye is suitable because control of the absorption with respect to the recording wavelength is easy. The azo dye may be obtained as a single azo compound or as a complex of a metal and one or more molecules of an azo compound.

In the embodiment, cobalt, nickel, or copper may be used for the center metal M of the azo metal complex so as to enhance the optical stability. However, without being limited thereto, there may be used for the center metal M of the azo metal comprex: scandium, yttrium, titanium, zirconium, hafnium, vanadium, niobium, tantalum, chrome, molybdenum, tungsten, manganese, technetium, rhenium, iron, ruthenium, osmium, rhodium, iridium, palladium, platinum, silver, gold, zinc, cadmium, or mercury and the like.

An azo compound includes an aromatic ring. Not only by applying various structures to the aromatic ring, but by adopting or getting various substituents for the aromatic ring, it is possible to optimize the characteristics of recording, preserving, reproduction stability, etc. As the substituent becomes bulky, there is a tendendy to improve the persistence to reproduction light. But at the same time, there is another endency to lower the recording sensitivity. From thism it is proposed to select a suitable substituent with which both characteristics of the persistence and the sensitivity are good. This substituent concerns the solubility of the solvent.

Differring from the recording mechanism of a dye-based information recording medium until now (whose recording laser wavelength is longer than 620 nm), in case of the invention relating to short wavelength laser recording (whose recording wavelength is 405 nm, for instance), the recording mechanism is independent of a physical change in the substrate and/or in the volume of the dye film. During reproducing, the dye is subjected to the irradiation of a feeble laser (weaker than the recording laser). Heat or light of this laser causes a gradual change in the arrangement or orientation of dye molecules in the recording layer, or in the spatial conformation or spatial arrangement of the dye molecules. However, bulky substituents in the dye molecules may disturb that change. In other words, the bulky substituent serves to improve the persistence to reproduction light.

The bulky substituent may be a substituent comprising three or more carbons for substituting an aromatic ring in dye molecule. Examples of the substituent include n-propyl group, isopropyl group, n-butyl group, 1-methylpropyl group, 2-methylpropyl group, n-pentyl group, 1-ethylpropyl group, 1-methylbutyl group, 2-methylbutyl group, 3-methylbutyl group, 1,1-dimethylpropyl group, 1,2-dimethylpropyl group, 2,2-dimethylpropyl group, cyclopentyl group, n-hexyl group, 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 3,3-dimethylbutyl group, 1-ethylbutyl group, 2-ethylbutyl group, cyclohexyl group, phenyl group, and the like. Incidentally, the substituent may include an atom other than carbon, such as oxygen, sulfur, nitrogen, silicon, fluorine, bromine, iodine, or the like.

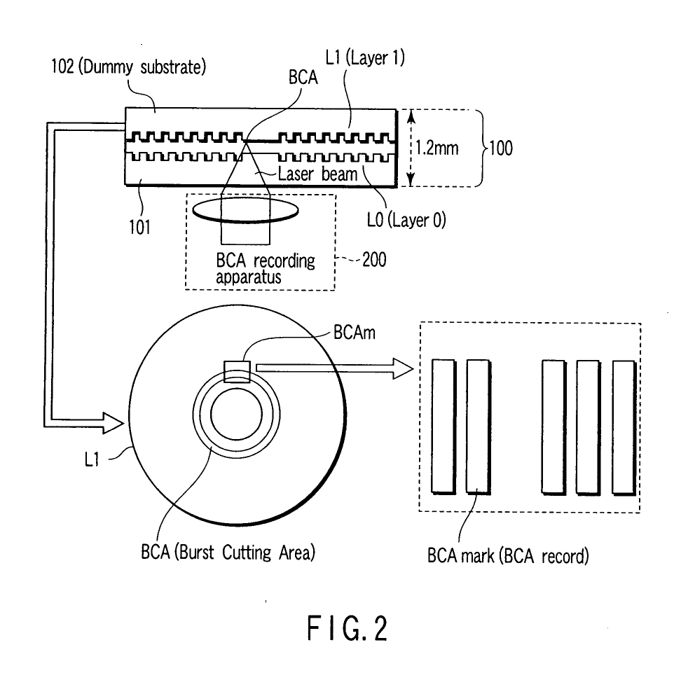

FIG. 2 shows formation of a burst cutting area (BCA) in the L1 layer of the write-once type single-sided multilayer (2 layers) optical disc of the embodiment. The L0 layer is disposed in the substrate 101 of a laser beam receiving surface side, the L1 layer is disposed to face the L0 layer, and a substrate 102 is arranged on the L1 layer, thereby constituting a bonded dual-layer disc 100 of a substrate thickness 1. 2 mm. On the L1 layer of the inner peripheral side of the disc 100, a burst cutting area (BCA) in which information unique to the disc is recorded in a barcode pattern is disposed.

Disc unique information is recorded beforehand in each optical disc during its manufacturing. The disc unique information recorded in this case is used for identifying the disc in, for example, copy protection. As shown in FIG. 2, in an optical disc such as a CD, a DVD, a BD, or a HD_DVD, such disc unique information (BCA record) is inscribed as a barcode pattern called BCA beforehand in an inner peripheral part of the disc. In the case of a reproduction-only dual-layer optical disc, the information is generally recorded in a deep layer when seen from an incident surface of a recording or reproducing light.

Recently, to satisfy a demand for a large capacity of an optical disc, a single-sided dual-layer optical disc has been developed for not only the reproduction-only type but also a recording type optical disc. To maintain compatibility with the reproduction-only type, the BCA signal is recorded in a deep layer when seen from an incident surface of a recording or reproducing light even in the recording type dual-layer optical disc. However, some problems occur in this case. A BCA recording method and problems when dual-layer formation is employed will be described below.

To record BCA in the disc, a method for inscribing a BCA pattern in a stamper which is a mold for forming an optical disc can be used. However, to record information unique to each one of the discs, for example, a BCA pattern is inscribed in a manufactured disc by a laser beam. Normally, to record BCA in the reproduction-only disc, a reflective film (aluminum, silver, or an alloy thereof) is completely burned by a laser beam to form a pattern. To record BCA in a phase change recording type disc, a pattern is formed by changing a phase of a recording film by a laser beam to change a reflectance.

On the other hand, in the case of the write-once type optical disc that uses an organic dye material, dye sensitivities are very high with respect to a wavelength. Thus, even when a current BCA recording device which uses a laser beam of a long wavelength (e.g., 650 nm, 680 nm or 780 nm) is applied to a next-generation optical disc (BD or HD_DVD) which uses a dye corresponding to a short wavelength (405 nm), a BCA pattern cannot be recorded satisfactorily. In this case, laser power of the BCA recording device may be increased, or a laser beam wavelength of the BCA recording device may be changed to match a data recording wavelength (405 nm). However, as the BCA information is recorded in the deep layer (L1) over the last layer (L0), and because of a very high focal depth of the BCA recording device (or parallel BCA recording light), the dye of the last layer also reacts in the case of this method. This reaction generates noise (interlayer crosstalk signal) during reproduction of a BCA signal.

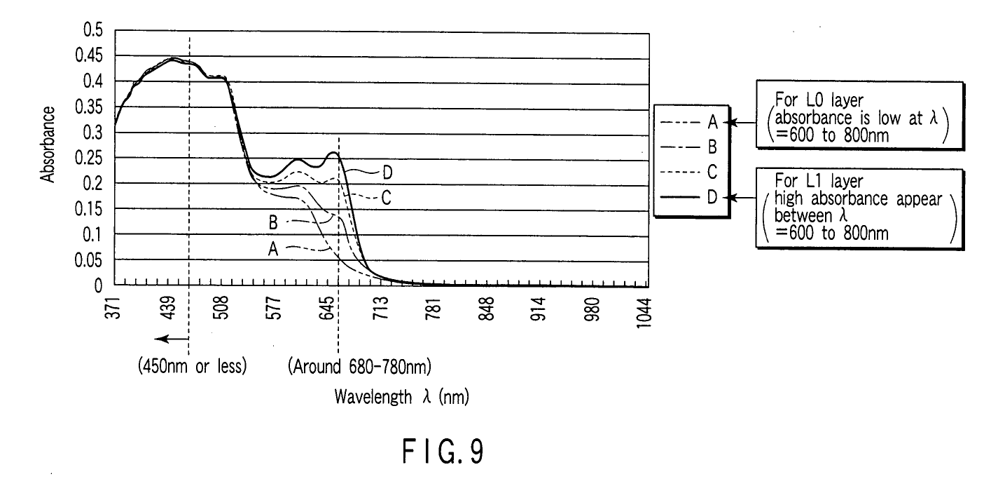

Thus, according to the embodiment, an organic material to be used is selected so that recording sensitivities with respect o a wavelength B can be higher in the deep layer (L1) in which BCA is recorded than the last layer (L0) in which no BCA is recorded, in which A (nm) is a wavelength used for data recording or reproducing, and B (nm) is a wavelength of the BCA recording device. By using a dye (two types of dyes of different sensitivities, such as a dye having a sensitivity of around 405 nm and a dye having a sensitivity of around 650 nm to 780 nm, are mixed) corresponding to a wavelength of the BCA recording device only for the deep layer (L1) while a wavelength used for recording real data (high-definition video data encoded by MPEG4AV) and a wavelength used for recording BCA information are different (A≠B), the BCA signal can be selectively recorded only in the deep side (L1). Referring to FIG. 9, an actual example of dye absorbance characteristics proper for the deep side (L1) in which the BCA is recorded will be described below.

The embodiment shows a write-once type optical disc which has a diameter of 120 mm and a thickness of 1.2 mm (two polycarbonate formed substrates of 0.6 mm are bonded) and includes two recording layers using organic dye materials. For a recording or reproducing light, an optical system of a wavelength (λ) 405 nm and a numerical aperture (NA) of 0.65 is used. For example, a track pitch between grooves of a data recording area is 400 nm, and a position of a BCA area is within a radius of 22.2 mm to 23.1 mm. For example, a BCA pattern is a barcode pattern having a width (tangential direction) of several tens μm and a length (diameter direction) of about several hundreds μm.

The embodiment is not limited to the aforementioned example. For example, an optical disc including a cover layer of 0.1 mm in its surface, an optical disc of a diameter 80 nm, a high-density track pitch pattern, a short-wavelength (λ is equal to or less than 400 nm) laser beam, or an optical system (objective lens) of a high numerical aperture (NA is 0.8 to 0.9) may be used.

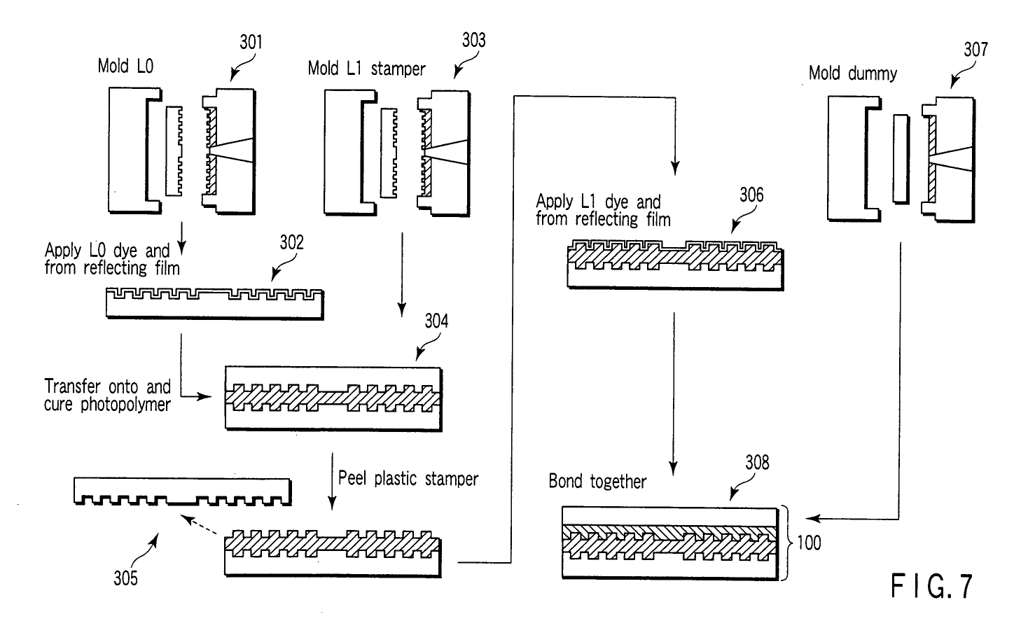

According to the embodiment, specific material examples of the write-once type multilayer optical disc are polycarbonate for the substrate; nickel for the stamper used for forming; an organic dye material of azo, diazo, cyanine, phthalocyanine, styryl, or a mixture of these for the recording layer; silver (Ag), aluminum (Al), gold (Au) or a metal compound based on these for the reflective film; and acrylic or epoxy ultraviolet curing resin for the adhesive. The materials are not limited to the above. However, the invention relates to a write-once type optical disc which includes a plurality of recording layers. For a single-sided dual-layer write-once type optical disc as a representative example, its manufacturing method will be described below referring to FIG. 7.

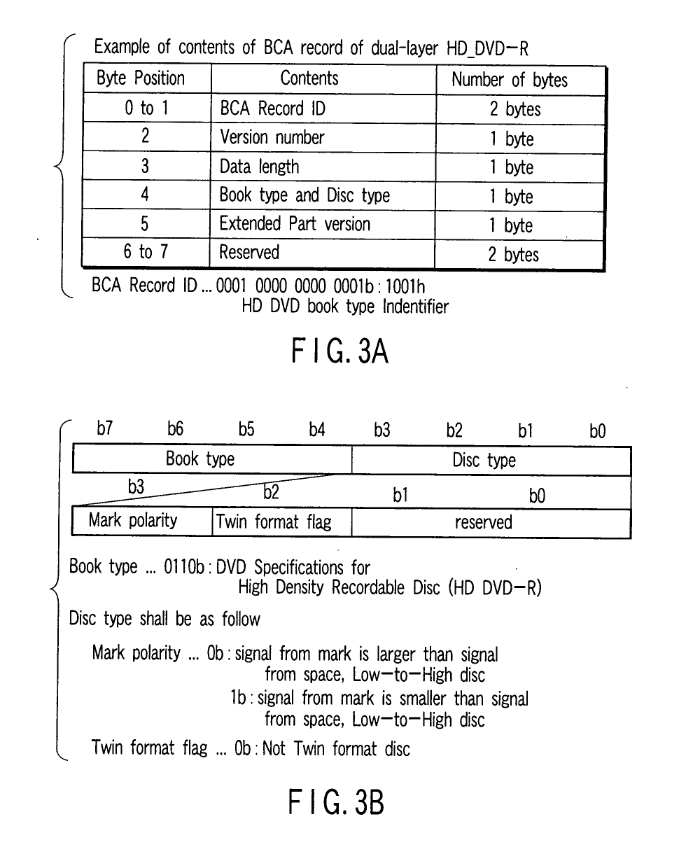

Each of FIGS. 3A and 3B shows a contents example of the BCA record recorded in the BCA of FIG. 2. As shown in FIG. 3A, in this record, a BCA record ID (indicating HD_DVD book type identifier) is written in relative byte positions 0 to 1, an application standard version number is written in a relative byte position 2, a data length is written in a relative byte position 3, a written standard book type and a disc type are written in a relative byte position 4, an extension part version is written in a relative byte position 5, and relative byte positions 6 to 7 are reserved for other information writing.

In the BCA record, sections of the written standard book type and the disc type with which the disc is complaint are as shown in FIG. 3B. That is, information indicating a HD_DVD-R standard can be written in the book type, and a mark polarity flag and a twin format flag can be described in the disc type.

The mark polarity flag of FIG. 3B indicates a “low-to-high” disc in which a signal from a recording mark is larger than a signal from a space (between adjacent marks) in the case of “0b”, and a “high-to-low” disc in which a signal from the recording mark is smaller than a signal from the space in the case of “1b”. The twin format flag indicates not a twin format disc in the case of “0b” but a twin format disc in the case of “1b”. In the case of the twin format disc, the disc (in which the BCA record has been recorded) includes two recording layers, and the layers include different formats (e.g., HD_DVD-Video format and HD_DVD-Video Recording format) defined by a DVD forum.

In the current DVD, there is no twin format disc. However, in the next-generation HD_DVD, there can be a twin format disc. Accordingly., permission of writing of the twin format flag in the BCA is very significant for the write-once type multilayer (2 layers) optical disc (disc for next-generation HD_DVD) of the embodiment.

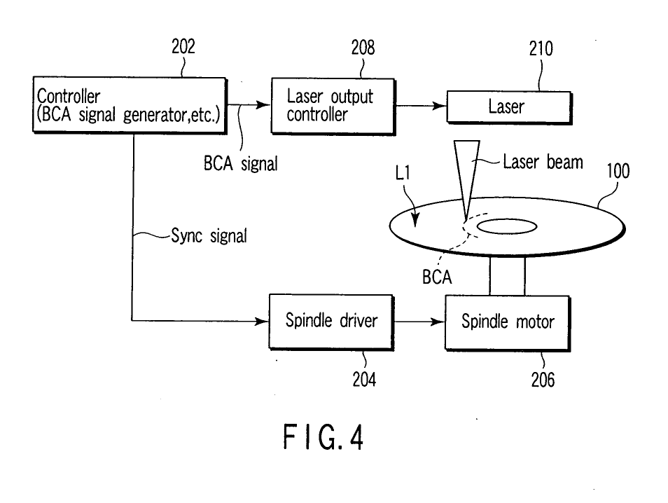

FIG. 4 shows a configuration example of a device for recoding specific information containing the BCA record of FIGS. 3A and 3B in the BCA of FIG. 2. Recording of the BCA signal (signal containing information such as the BCA record of FIGS. 3A and 3B) by the BCA device is carried out in the completed disc 100. A laser 210 is modulated in accordance with a BCA signal from the controller 202, and a barcode BCA mark is recorded in synchronization with rotation of the disc 100. For a laser wavelength of the BCA recording device, one of wavelengths within a range of 600 nm to 800 nm (generally 650 nm to 780 nm or 680 nm to 780 nm) is employed. A BCA recording place is generally near an inner peripheral part radius 22.2 mm to 23.1 mm of the L1 layer in the case of a dual-layer optical disc. When BCA recording is carried out, a laser beam is applied over the L0 layer to the L1 layer. According to the embodiment, an absorbance (sensitivity) is adjusted at a wavelength 650 nm to 780 nm (or 680 nm to 780 nm) (sensitivity of the L1 layer>sensitivity of the L0 layer). Thus, the BCA signal can be accurately recorded selectively only in the L1 layer.

By adjusting the dye sensitivity (absorbance for a used wavelength) of each layer, the BCA signal can be recorded in the next-generation optical disc while a laser wavelength and lower power of the BCA recording device generally used in a current DVD manufacturing line are maintained. As the BCA signal can be selectively recorded only in the L1 layer, there is no extra crosstalk noise from the L0 layer during reproduction.

That is, according to the embodiment, the dye sensitivity of each layer (L0, L1) is adjusted (e.g., organic material in which a sensitivity or an absorbance of the L1 layer dye at 600 nm to 800 nm, 650 mm to 780 mm, or 680 nm to 780 nm is larger than that of the L0 layer sensitivity). Accordingly, the BCA signal can be recorded in the next-generation optical disc (single-sided dual-layer HD_DVD-R) while the laser wavelength and the laser power of the BCA recording device generally used for the current DVD manufacturing line) are maintained. In this case, as the BCA information is selectively recorded only in the L1 layer, no extra crosstalk noise enters from the L0 layer during BCA signal reproduction.

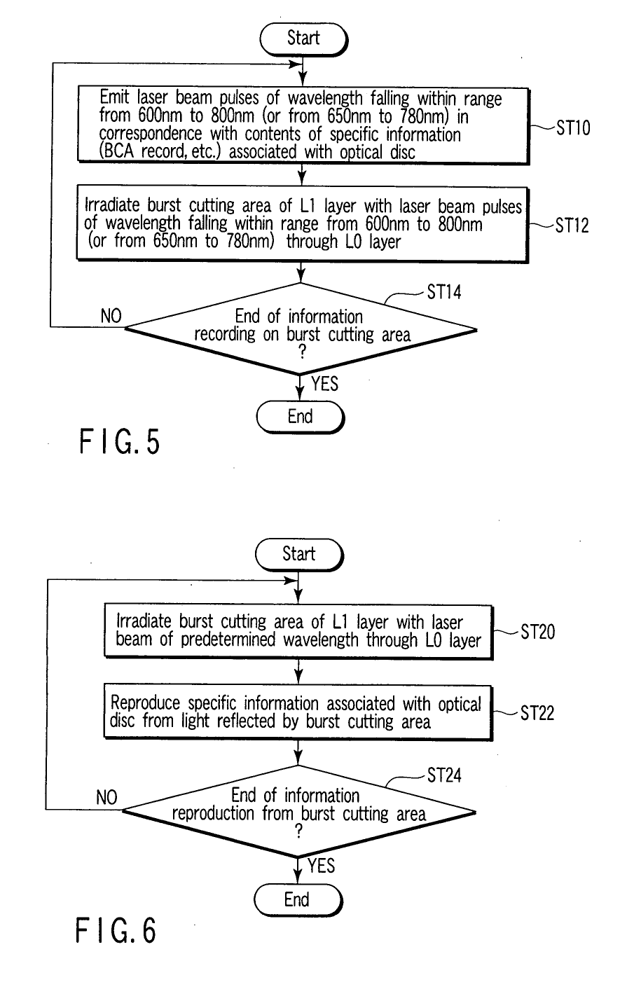

FIG. 5 is a flowchart showing an example of a process of recording (BCA post cutting) specific information in the L1 layer of the write-once type single-sided multilayer (2 layers) of FIG. 1 or FIG. 2. Upon supplying of the BCA signal containing the specific information such as the BCA record of FIGS. 3A and 3B from the controller 202 of FIG. 4 to a laser output control section 208, a laser beam of one wavelength among wavelengths of 600 nm to 800 nm (or 650 nm to 780 nm, or 680 nm to 780 nm) is pulsively emitted from a laser diode 210 (ST10). The laser beam pulse thus emitted is applied over the L0 layer of the disc 100 shown in FIG. 1 or FIG. 2 to the BCA recording place of the L1 layer (ST12). This application is continued in synchronization with rotation of the disc 100. When there is no more information to be recorded in the BCA (YES in ST14), the BCA post cutting over the L0 layer to the L1 layer is finished.

FIG. 6 is a flowchart showing a process of reproducing specific information from the L1 layer of the write-once type single-sided multilayer (2 layers) optical disc of FIG. 1 or FIG. 2. When information recorded in the BCA is reproduced, a laser beam of a predetermined wavelength (405 nm to 650 nm) is applied over the L0 layer to the BCA of the L1 layer (ST20). Specific information (BCA record of FIG. 2) regarding the optical disc is read from its reflected light (ST22). This reading is continued in synchronization with rotation of the disc 100. When there is no more information to be read from the BCA (YES in ST24), BCA reproduction from the L1 layer over the L0 layer is finished.

FIG. 7 is a diagram showing a manufacturing process example of the write-once type single-sided dual-layer optical disc of the embodiment. Referring to FIG. 7, a method for manufacturing this dual-layer write-once type optical disc will be described. Because of formation of a pattern on a photopolymer, a process is complex as compared with a single layer disc or a reproduction-only (ROM) disc. However, there is basically no difference in manufacturing method between the current DVD-R and the next-generation HD_DVD-R.

First, a substrate mold of an L0 layer is prepared by injection molding (block 0301). A substrate material is generally a polycarbonate. A stamper used for forming the L0 layer is manufactured from a laser-exposed photoresist pattern by Ni plating. Dimensions of the substrate mold are 120 mm in diameter, 15 mm in inner diameter, and 0.6 mm in thickness. An organic dye material for forming a recording layer is applied on the substrate by a well-known spin-coating method, and a metal film (silver or silver alloy) which is a reflective film is formed by a well-known sputtering method (block 0302). The L0 layer is semitransparent so that a laser beam can be transmitted.

Simultaneously, a plastic stamper which is a mold of an L1 layer is similarly manufactured by injection molding (block 0303). A molding material is generally a cycloolefin polymer. However, a polycarbonate or acrylic may be used. An Ni stamper of the L1 layer is similarly manufactured by plating of a laser-exposed photoresist. However, pattern concaves and convexes are reverse to those of the L0 layer.

The L0 layer having the recording layer formed thereon and the plastic stamper are bonded together via a photopolymer, and irradiated with ultraviolet rays to be cured (block 0304). Subsequently, the plastic stamper is peeled off to bare a photopolymer layer to which the L1 layer pattern has been transferred (block 0305). An organic dye material for forming a reflective layer is applied on the photopolymer of the L1 layer by spin-coating, and a metal film (silver or silver alloy) which is a reflective film is formed by a sputtering method (block 0306).

Simultaneously, a dummy plate (material is a polycarbonate) is prepared by injection molding (block 0307), and bonded by an ultraviolet curing adhesive to complete a dual-layer write-once type optical disc (block 0308). For the dummy plate, surface coating for user printing by an ink jet printer may be implemented, or a pattern such as a brand name or a product name of a disc manufacturer (or seller) may be added (not shown).

The aforementioned disc structure and manufacturing process are similar between the DVD-R and the HD_DVD-R. However, dye recording principles are different. In the red-color DVD-R, an organic dye irradiated with a laser beam changes in volume to destroy a groove pattern on the plastic substrate, thereby forming a recording mark (FIG. 8A). In the blue-color HD_DVD-R, a chemical change of an organic dye irradiated with a laser beam causes a change in optical characteristics to form a recording mark (FIG. 8B).

Both recording principles may have advantages and disadvantages. However, the method of forming the recording mark by destroying the groove pattern as in the case of the DVD-R is irreversible because of a change in physical shape, and high in reproduction durability. This recording principle is not used in the case of the HD_DVD-R. It is because a volume change or the amount of generated heat during dye reaction is not enough to destroy a polycarbonate resin of the groove pattern. However, for the L1 layer of the write-once dual-layer optical disc, as described above, its material is a photopolymer (generally, an acrylic resin is a base), and its hardness or heat characteristics can be controlled relatively freely.

Thus, by setting the photopolymer 104 for forming the L1 layer pattern to be soft (elastic modulus is 300 MPa or less (at 25° C.) or 1500 MPa or less (at 100° C.) or weak to heat (glass transition temperature is 150° C. or less) as compared with the polycarbonate resin 101 for forming the L0 layer pattern, in the HD_DVD-R that uses a blue light, recoding can be carried out at least in the L1 layer, and margins can be obtained for various characteristics including reproduction durability.

In this case, needless to say, the recording method not accompanied by physical shape changes have advantages (high sensitivity or the like). There are various organic dye characteristics (material which causes reaction to deform the polycarbonate), and characteristics (recording sensitivities or the like) suitable for the L0 and L1 layers are different. Accordingly, for example, reversely to the aforementioned case, a hard and heat-resistant photopolymer may be used for the L1 layer, and recording accompanied by a physical change may be executed only in the L0 layer.

Generally, its reflectance change is high-to-low (reflectance is lower in a recording mark portion than in other unrecorded portions) in the case of recording accompanied by a physical shape change (groove pattern is destroyed), and its reflectance change is low-to-high (reflectance is higher in a recording mark portion than in other unrecorded portions) in the case of recording only accompanied by a chemical optical change. Both reflectance changes have advantages and disadvantages, and thus recording methods may be different between the two layers. For example, a reflectance at the time of nonrecording is set high (high-to-low) in a layer subjected to first recording, while a reflectance is set low (low-to-high) in the other layer. Thus, a write-one type optical disc in which writing in the first layer is stabilized (especially focusing is stabilized) and generally single-stroke writing is carried out (writing moves to a next layer after writing in the first layer is finished) and which has excellent optical characteristics can be manufactured.

FIG. 8A shows a recording mark (high-to-low) accompanied by substrate deformation caused by laser power during recording, and FIG. 8B shows a recording mark (low-to-high) not accompanied by substrate deformation during recording. As optical changes are recorded in both cases accompanied by substrate deformation (FIG. 8A) and not accompanied by substrate deformation (FIG. 8B), information can be recorded or reproduced.

FIG. 9 shows that a BCA dye material for the layer L1 can be obtained by mixing a proper amount of a CD-R/DVD-R dye material with a dye material for the layer L0. Specifically, an example of a relation between absorbances and wavelengths of the organic dye materials used for the layers L0 and L1 is shown.

As an example, a graph of dye absorbance characteristics proper for the deep layer (L1) in which BCA information is recorded is shown. The dye shown in FIG. 9 is a dye for the next-generation optical disc (BD, HD_DVD) in which data is recorded or reproduced by a wavelength of 405 nm. Naturally, there are sensitivities around 405 nm. In addition, as shown in a graph D of FIG. 9, certain recording sensitivities are provided within a range of 680 nm to 780 nm (or 650 nm to 780 nm, or 600 nm to 800 nm) which is a laser wavelength of a general BCA recording device. By using an organic dye material having sensitivities at a laser wavelength to be used, BCA information can be correctly recorded over the first layer (L0) in the deep layer (L1). On the other hand, as shown in a graph A of FIG. 9, for the dye of the first layer (L0), recording sensitivities within 680 nm to 780 nm (or 650 nm to 780 nm, or 600 nm to 800 nm) are set relatively lower. Accordingly, the BCA information can be selectively recorded in the deep layer (L1) alone.

<L1 Layer Dye Material Having Sensitivities Within Range of 600 nm to 800 nm for BCA Recording>

According to the embodiment, the write-once type multilayer optical disc is a disc in which data is recorded or reproduced by a wavelength of 405 nm. Thus, organic dye materials having light absorption at the wavelength 405 nm are used for both of the layers L0 and L1. For the dye of the L1 layer, light absorption can be provided within a range of 600 nm to 800 nm so that BCA recording using a laser beam of a wavelength within a range of 600 nm to 800 nm can be carried out. For example, while a dye having light absorption only near the wavelength 405 nm is used for the layer L0 (graph A in which light absorption is small or there is none within a range of 600 nm to 800 nm), a dye mixed with another dye having light absorption within a range of 600 nm to 800 nm is used for the layer L1 (graph D).

Such a mixed dye is used only for a BCA recording place of the layer L1. To simplify the manufacturing process (and unit price reduction of mass-produced discs), however, the mixed dye (graph D) is used for the entire layer L1. When the mixed dye (graph D) is used for the entire layer L1, not only BCA recording or reproducing can be carried out over the layer L0 in the layer L1, but also a data area of the layer L1 can deal with both of blue-laser high-density recording and red-laser (relatively) low-density recording.

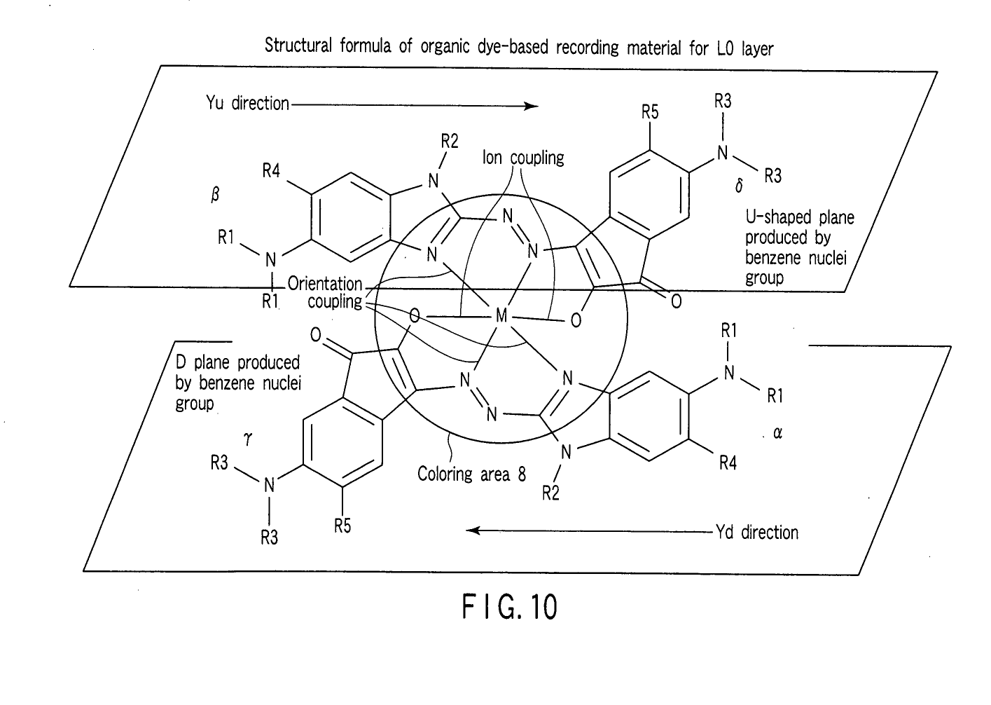

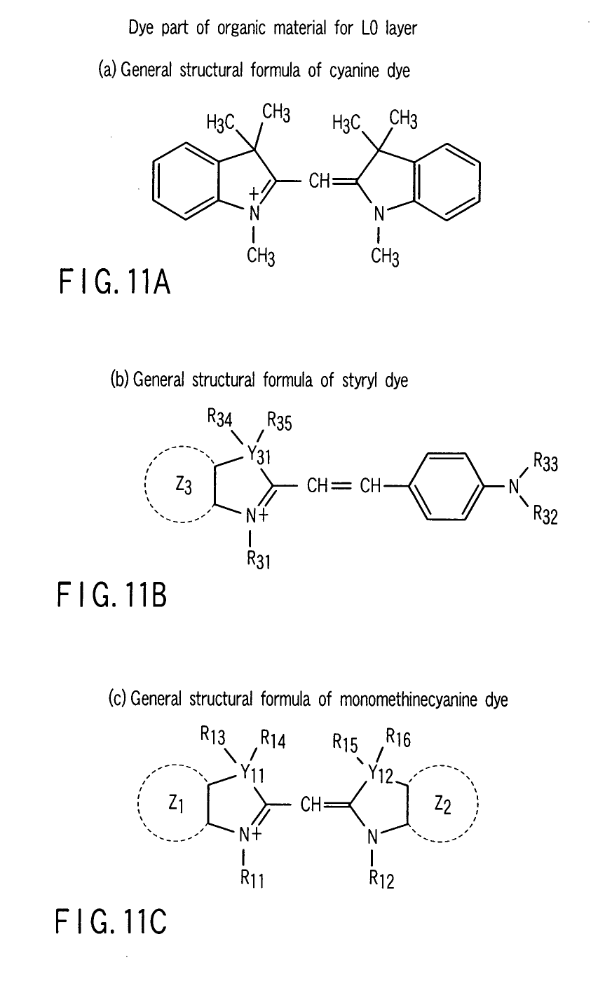

FIG. 10 is a diagram showing a specific example of a metal complex portion of the organic material L0, and each of FIGS. 11A to 11C shows a specific example of a dye portion of the organic material for the layer L0. A circular peripheral area around a center metal M of the azo metal complex shown in FIG. 10 is a coloring area 8. Passage of a laser beam through the coloring area 8 causes resonance of local electrons therein with an electric field change of the laser beam to absorb energy of the laser beam. A value obtained by converting a frequency of an electric field change in which the local electrons resonate most greatly to easily absorb energy is represented by a maximum absorption wavelength λmax. As a length of the coloring area 8 (resonance range) shown in FIG. 10 is longer, the maximum absorption wavelength λmax is shifted more to a long wavelength side. Changing of atoms of the center metal M of FIG. 10 changes a presence range of local electrons around the center metal M (or how much does the center metal M draw the local electrons to the vicinity of the center), thereby changing a value of the maximum absorption wavelength λmax. For example, through selection of a maximum absorption wavelength λmax near 405 nm, an organic material having sensitivities (light absorption) at a wavelength 405 nm can be obtained.

For the L0 layer dye material having light absorption at the wavelength 405 nm, an organic metal complex portion having a general structural formula shown in FIG. 10, and an organic dye material having a structure combined with a dye material portion shown in each of FIGS. 11A to 11C can be used. For the center metal M of the organic metal complex, generally, cobalt or nickel (or scandium, yttrium, titanium, zirconium, hafnium, vanadium, niobium, tantalum, chromium, molybdenum, tungsten, manganese, technetium, rhenium, iron, ruthenium, osmium, rhodium, iridium, palladium, platinum, copper, silver, gold, zinc, cadmium, or mercury) can be used. For the dye material portion, a cyanine dye, a styryl dye, and monomethine cyanine dye having general structural formulas shown in FIGS. 11A to 11C can be used.

For the L1 layer dye material having light absorption not only at the wavelength 405 nm (equal to or less than 450 nm) but also within a range of 600 nm to 800 nm (or 650 nm to 780 nm, or 680 nm to 780 nm), the following can be used. That is, a CD-R or DVD-R dye having light absorption within a range of wavelengths 600 nm to 800 nm (or 650 nm to 780 nm, or 680 nm to 780 nm) using the L0 layer dye material as a base is mixed. Accordingly, in addition to the light absorption at the wavelength 405 nm for data recording, light absorption can be provided within a range of wavelengths 600 nm to 800 nm (or 650 nm to 780 nm, or 680 nm to 780 nm) used for BCA recording. For the CD-R or DVD-R dye to be mixed, specifically, a well-known organic material such as an azo dye, a cyanine dye or a phthalocyanine dye is available. For example, its practical mixing amount is about 10 wt. %.

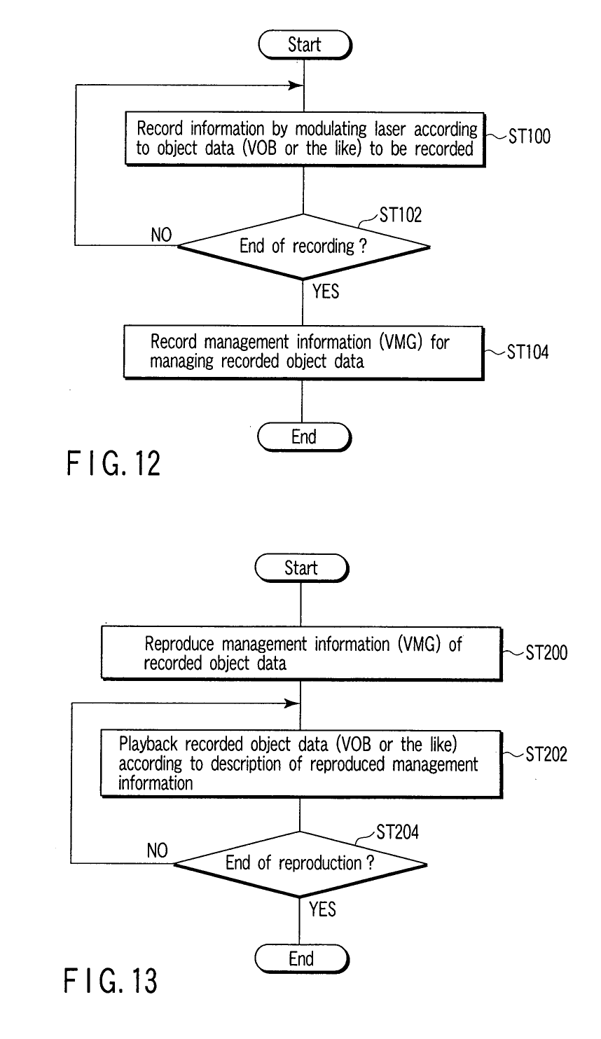

FIG. 12 is a flowchart showing a recording method which uses the optical disc (disc using an organic dye material which causes no deformation or change in a mark after recording for a recording layer) 100 of the embodiment. For example, a modulated laser beam of a wavelength 405 nm is applied from an optical pickup of a disc drive (not shown) to a recording target layer (L0 or L1) to record object data (VOB in DVD or HD_DVD) (ST100). Upon an end of the recording (ST102Y), management information (VMG in DVD or HD_DVD) regarding the recorded object data is written in the disc 100 (ST104) to finish first recording.

FIG. 13 is a flowchart showing a reproducing method which uses the optical disc (disc using an organic dye material which causes no deformation or change in a mark after recording for a recording layer) 100 of the embodiment. The management information is read from the disc 100 in which the object data and the management information have been recorded by the process shown in FIG. 12 by, for example, a laser beam of a wavelength 405 nm (ST200). The read management information is temporarily stored in a work memory of a reproduction device (not shown). The reproduction device refers to information regarding a reproduction process in the stored management information to reproduce the recorded object data (ST202). This reproduction is finished when the user instructs a reproduction end or when reproduction process information of the management information indicates a reproduction end (ST204Y).

### Effect of Embodiment

In the write-once type multilayer optical disc such as a dual-layer HD_DVD-R, one layer is not accompanied by substrate resin deformation during mark recording (FIG. 8A), and the other layer is accompanied by deformation (FIG. 8B). For this purpose, materials such as a dye and/or an ultraviolet curing resin (photopolymer) are selected. Thus, even while a polycarbonate (PC) as a material for the substrate 101 of the layer L1 is maintained, a selection range of various materials such as a dye for the layer L1 and an ultraviolet resin (photopolymer) for the intermediate layer 104 can be widened.

### Summary of Embodiment

By defining characteristics of the photopolymer (104) of the layer L1, recording principles of the two layers (L0 and/or L1) are different (there is a physical shape change or no change) in the write-once type dual-layer optical disc.

Accordingly, organic dye materials which simultaneously satisfy various characteristics such as sensitivities and reproduction durability in the layers can be designed.

When the recording principles are different, whether it is high-to-low recording or low-to-high recording is different. Thus, a disc which simultaneously satisfies optical characteristics proper for the write-once type optical disc can be designed.

The invention is not limited to the embodiment. At current and future implementation stages, based on available technologies of each stage, various changes can be made without departing from the spirit and scope of the invention.

Embodiments can be properly combined to be implemented as much as possible, and effects of the combination are provided. Furthermore, the embodiment includes inventions of various stages, and various inventions can be extracted from a proper combination of a plurality of disclosed components. For example, even when some are removed from all the components of the embodiment, a configuration in which the components have been removed can be extracted as an invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A write-once type optical disc comprising:
a plurality of recording layers in which recording or reproduction is carried out by a laser beam of a wavelength equal to or less than 450 nm, each of the recording layers including a recording film using an organic dye, wherein the plurality of recording layers includes a layer in which a groove pattern around a recording mark is deformed when information is recorded, and a layer in which the groove pattern around the recording mark is not deformed when information is recorded.

2. The optical disc according to claim 1, further comprising one or more layers in which groove patterns made of photopolymers are formed, wherein a glass transition temperature of the photopolymer is set to 150° C. or less, or an elastic modulus is set to 3000 MPa or less at 25° C., or an elastic modulus is set to 1500 MPa or less at 100° C., and the groove pattern around the recording mark of the recording layer on the photopolymer is deformed when information is recorded by the laser beam.

3. The optical disc according to claim 1, further comprising one or more layers in which groove patterns made of photopolymers are formed,
wherein a glass transition temperature of the photopolymer is set to 150° C. or more, or an elastic modulus is set to 3000 MPa or more at 25° C., or an elastic modulus is set to 1500 MPa or more at 100° C., and the groove pattern around the recording mark of the recording layer on the photopolymer is not deformed when information is recorded by the laser beam.

4. A write-once type optical disc comprising:
a plurality of recording layers in which recording or reproduction is carried out by a laser beam of a wavelength equal to or less than 450 nm, each of the recording layers including a recording layer using an organic dye,
wherein the plurality of recording layers includes a high-to-low layer in which a reflectance of a recording mark portion is lower than reflectances of other unrecorded portions when information is recorded, and a low-to-high layer in which a reflectance of the recording mark portion is higher than reflectances of the other unrecorded portions when information is recorded.

5. The optical disc according to claim 4,
wherein the high-to-low layer is a layer in which a groove pattern around a recording mark is deformed when information is recorded, and the low-to-high layer is a layer in which the groove pattern around the recording mark is not deformed when information is recorded.

6. A recording method which uses the optical disc of claim 1, comprising:
recording object data in the recording layer by modulated laser power; and
recording management information of the object data in the recording layer by the modulated laser power.

7. A recording method which uses the optical disc of claim 4; comprising:
recording object data in the recording layer by modulated laser power; and
recording management information of the object data in the recording layer by the modulated laser power.

8. A reproducing method which uses the optical disc of claim 1, comprising:
reproducing management information from the recording layer by a laser beams of a predetermined wavelength; and
reproducing object data managed based on the management information from the recording layer by the laser beam.

9. A reproducing method which uses the optical disc of claim 4, comprising:
reproducing management information from the recording layer by a laser beams of a predetermined wavelength; and
reproducing object data managed based on the management information from the recording layer by the laser beam.
